(19) United States
(12) Patent Application Publication
(10) Pub. No.: US 2005/0120098 A1
(43) Pub. Date: Jun. 2, 2005

(54) Method and device for the exchange of data

(75) Inventors: Hans-Joachim Beck, Rheinstetten (DE); Roland Pietsch, Doerrenbach (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/941,100

(22) Filed: Sep. 15, 2004

Related U.S. Application Data
(63) Continuation of application No. PCT/DE03/03695, filed on Nov. 7, 2003.

(30) Foreign Application Priority Data
Nov. 7, 2002 (DE) 102 51 868.8

(51) Int. Cl. G06F 15/177; G06F 15/16

(52) U.S. Cl. 709/220; 709/249

(57) ABSTRACT

A device and method thereof for exchanging data (D) between components (K1 to Kn) of a communication network (2), particularly a computer network, which are arranged hierarchically in a plurality of levels (E1 to En). In the method, a respective component (K1 to Kn) is assigned a number of application-specific and/or hierarchy-specific configuration criteria (M1 to Mn), which are processed by at least one configuration module (4) associated with all the levels (E1 to En). As such, when the data (D) are transmitted between components (K1 to Kn) of a single level and/or several levels (E1 to En), the configuration criteria (M1 to Mn) stored in the configuration module (4) are transmission-specifically and/or reception-specifically processed and/or adapted at one of the node element (6) associated with a respective level (E1 to En).

This is a Continuation of International Application PCT/DE03/03695, with an international filing date of Nov. 7, 2003, which was published under PCT Article 21(2) in German, and the disclosure of which is incorporated into this application by reference.

### FIELD AND BACKGROUND OF THE INVENTION

The invention relates to method and a device for exchanging data between components of a communication network, particularly a computer network, hierarchically arranged in a plurality of levels. The invention further relates to a method for configuring components of a communication network that are hierarchically arranged in a plurality of levels.

In communication networks of this type, a plurality of data processing units, e.g., central servers and local computers, communicate with each other via multiple computer nodes. Each computer node or node element is assigned one or more applications, which are processed by the computers and/or servers associated with the respective computer node.

With increasing globalization, computers and servers are frequently interconnected by different applications or configurations to process one and the same project. Because of the computer-specific applications, global settings or configurations are therefore required to enable joint work on one and the same project. Based on such a separation between global and local applications, global settings take precedence over project-specific and computer-specific settings for higher-level projects. For example, if computer networks in China are networked with computer networks in Germany to process a project, these computer networks are assigned the global language setting “English” for the joint processing of the project. This can result in incorrect entries made in a non-native language. One of ordinary skill in the art will recognize that these incorrect entries could cause the network to malfunction, and thus be dangerous, such as when running safety applications. Furthermore, due to the global default settings, collisions with local settings may occur, or the data may be incorrectly processed because the settings are incorrectly identified within the context. Moreover, any changes in local and/or central configurations require an extensive and complex, and thus time-consuming and costly adaptation of the computers and/or servers involved in the data exchange.

### OBJECTS OF THE INVENTION

It is therefore an object of the invention to provide a method for exchanging data between components of a communication network, particularly a computer network, hierarchically arranged in a plurality of levels to enable computers of different configurations to exchange data in a particularly simple manner. It is a further object of the invention to provide a device that is particularly suitable for carrying out this method. It is yet another object of the invention to provide a method for configuring the components for different settings that involves little complexity and is particularly reliable.

### SUMMARY OF THE INVENTION

According to one formulation of the invention, the first of the aforementioned objects is attained in a method for exchanging data between components of a communication network, particularly a computer network, hierarchically arranged in a plurality of levels by assigning the respective component at least one of application-specific and hierarchy-specific Configuration criteria. When data are transmitted between components of a single level or several levels, these criteria are processed at a node element associated with the corresponding level using at least one configuration module associated with all levels, such that the corresponding configuration criteria stored in the configuration module are processed and/or adapted in a reception and/or transmission-specific manner.

The invention is based on the idea of processing a “networked” project, in which a plurality of components, e.g., computers, servers and/or local computer networks which are interconnected in a computer network, work on this project with different factory settings or configurations. In this case, global settings relating to all computers and/or servers are centrally stored and thus predetermined, and computer-specific and/or application-specific settings are locally stored and thus predetermined. A separation of this type should be avoided, however. In particular, global settings should be capable of being changed locally on individual components and vice versa. In addition, a locally applicable setting of one of the components should also be capable of being adopted by other components without additional complexity. For this purpose, each component is defined by its configuration criteria, which are stored in the configuration module, also referred to as container. In a data exchange, these criteria are taken into account and adapted using a node element that represents a hierarchical level.

In other words, the data to be exchanged are processed, output and/or stored using the global and/or local configuration criteria stored in the configuration module. The configuration criteria are information about the number and type of settings regarding the respective component. However, the configuration criteria of the corresponding component do not represent any knowledge regarding the semantics of the settings. Hence, when data are exchanged among a plurality of components within an individual level or a plurality of components of different levels, the corresponding configuration criteria are taken into account at the associated node elements in such a way that the data are correspondingly processed, particularly copied, moved and/or deleted. The data transmission in the different applications to be linked is processed at the node elements using the component-independent configuration module. The use of the configuration module at the node element thus enables a transparent and component-independent data transmission.

To take the configuration criteria into account across levels, the configuration module is generated and stored component-specifically, group-specifically, topographically and/or centrally. For example, in a centrally generated configuration module, which depending on type and configuration includes both global and local settings, the central configuration criteria, on the one hand, and the local configuration criteria relating to the data exchange, on the other hand, are automatically processed when the data are exchanged. In other words, in a data exchange, the settings—whether global or local—are not processed by the component itself but by the configuration module. This means that the configuration module automatically generates and processes the settings and/or configuration criteria component-specifically in a horizontal data exchange, group-specifically in a function-specific or project-specific data exchange and/or topographically and/or centrally in a vertical data exchange among several levels. Hence, the persistence of the settings and/or configuration criteria is not handled by the associated component itself. For example, in a data exchange within a project in which a terminal or computer are to be used, the configuration criteria are automatically transmitted and copied by means of the configuration module.

To take into account both functional and hierarchical settings, different node elements are predetermined. To take into account a functional and/or structural principle of the communication network, the node elements are predefined for each level—functional level or structural level. For example, corresponding to the functional levels—1st level=project, 2nd level=partial project, 3rd level=integration function, 4th level=autonomous function; or the structural levels—1st level=company, 2nd level=organization unit, 3rd level=group, 4th level=individual and 1st level=Internet, 2nd level=Intranet, 3rd level=project network, 4th level=autonomous computer—an associated node element each is generated hierarchically.

The configuration module is preferably designed as a container. A container in this context is defined as a database or a structured text. The configuration criteria are, for example, defined as a structured text for a combined group, as follows: Group with the following text fields: name=“editor,” color=“red,” language=“English.” The configuration criteria, which are centrally and/or locally stored in the configuration module, describe central and/or local applications, that is to say factory settings or configurations in the form of simplified text information. The configuration criteria therefore do not include any information on the syntax or semantics of the data to be transmitted. Instead, they include type-coded attributes or criteria by means of which the components are linked with different applications. Their data are processed, i.e., exchanged, copied and/or deleted, with the same architecture. For example, during transmission, the directory of a file or a component is mapped from a source system, i.e., a transmitting component, to the directory of the file or the component of a target system, i.e., a receiving or newly generated component, using the configuration criteria at the node element. This enables a uniform, and where applicable, flexible adaptation of the architecture in the corresponding components on both sides of the transmission.

Preferably, computer network-specific settings are defined as hierarchy-specific configuration criteria. For example, in a worldwide communication network, the defined computer network-specific settings are the communication type and the communication software to be used, e.g. Lotus Notes or Microsoft Explorer. As an alternative or in addition, computer-specific settings are defined as application-specific configuration criteria. For example, the language, the document type and the data structure are defined as computer-specific settings.

For a trouble-free transmission of data between components of different levels with different settings, the configuration criterion of a topographically lower component is preferably determined by the configuration criterion of a topographically higher component, or vice versa. Components with identical configuration criteria are preferably combined into a group. This ensures not only fast and reliable communication between components of one and the same group but also simple and fast maintenance of the configuration criteria if the configuration changes within this group. In other words, standardizing the configuration criteria in the entire communication network enables a flexible adaptation of both the architecture and configurations corresponding to local and/or central distributions of the components.

As an alternative or in addition, if one of the configuration criteria changes on one of the components, the corresponding configuration criterion in the subsequent components in the hierarchy is adapted, or vice versa. In other words, in case of structural changes in a project or a network structure, the components referencing the project or the network structure must likewise be adapted to ensure sufficient stability and consistency in the data transmission.

According to the invention, the object with respect to the method for configuring components of the communication network hierarchically arranged in a plurality of levels is attained by assigning the respective component a number of application-specific and/or hierarchy-specific configuration criteria. These criteria are processed using at least one configuration module associated with all the levels, such that, when data are transmitted between components of a single level or several levels, the corresponding configuration criteria stored in the configuration module are processed and/or adapted in a transmission-specific and/or reception-specific manner at one of the node elements associated with the corresponding level. Because of this component-independent similar configuration of all the heterogeneous and, if required, hierarchically linked components present in the communication network, the components can be quickly and easily adapted and configured, irrespective of the local and/or global operating systems, programming languages, etc. New components can be quickly and reliably integrated in the communication network by simply copying identical configuration modules.

The object with respect to the device for exchanging data between components hierarchically arranged in a plurality of levels is attained according to the invention by assigning the respective component a number of application-specific and/or hierarchy-specific configuration criteria. At least one configuration module associated with all the levels and a node element associated with a respective level are provided for the transmission-specific and/or reception-specific adaptation of the respective configuration criteria stored in the configuration module for data transmission between components of an individual level and/or several levels. The configuration module is advantageously configured and stored component-specifically, group-specifically, topographically and/or centrally. In a preferred embodiment, the configuration module is designed as a container, particularly a database or a structured text.

The advantages achieved by the invention are, in particular, that a configuration module formed by standardized configuration criteria, its transmission and its independent processing during data transmission, make it possible to link largely independent heterogeneous components with different operating systems and programming languages. In addition, such a distributed system of heterogeneous components can be very easily adapted and configured with respect to new settings. Moreover, the data exchange with components provided with such a configuration module or interface is simple and efficient.

### BRIEF DESCRIPTION OF THE DRAWINGS

Exemplary embodiments of the invention will now be described in greater detail with reference to the drawings, in which:

FIG. 1 is a schematic of a device for exchanging data between components of a communication network hierarchically arranged in a plurality of levels,

FIG. 2 is a schematic of a node element associated with a level for processing configuration criteria associated with the components, and

FIG. 3 is a schematic of component-specific configuration modules for storing the configuration criteria.

### DETAILED DESCRIPTION OF THE EXEMPLARY EMBODIMENTS

To facilitate understanding of the invention, corresponding components are provided with identical reference numerals in the Figures.

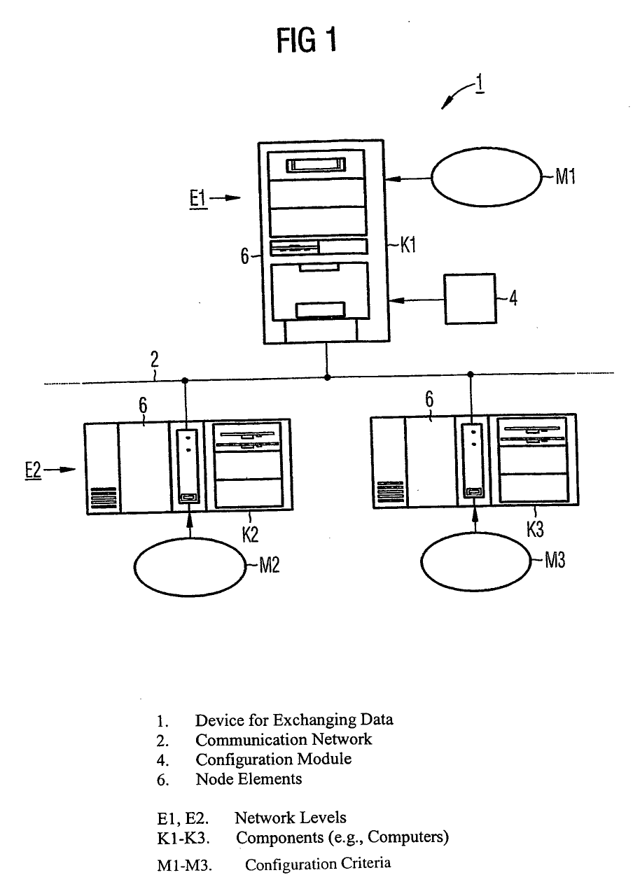

FIG. 1 shows a device 1 for exchanging data D between components K1 to K3 of a communication network 2, particularly a computer network, which are hierarchically arranged in a plurality of levels E1 to E2. The communication network 2, e.g., a wireless or wire-bound network, an Ethernet bus or a radio network, hierarchically interlinks the components K1 to K3 in a tree structure. Alternatively, the components K1 to Kn can also be interlinked radially or bidirectionally.

The components K1 to K3 are, for example, servers, computers or other data processing units. During joint work on a project within a company, or by several national companies, the components K1 to K3, which are interlinked via the communication network 2, can have different, e.g., hierarchy-specific or application-specific configuration criteria M1 to M3. For example, the component K1 is a central server for storing data D of the project. This central server is described by global and cross-project configuration criteria M1.

The components K2 to K3 configured, for example, as autonomous computers, are described by similar and/or additional configuration criteria M2 to M3. For example, the component K2 is code-optimized and the component K3 runtime-optimized. Such different application processes, which are described by the configuration criteria M1 to M3, can cause errors in the data exchange among the components. To avoid this, a configuration module 4 including the configuration criteria M1 to M3 is defined. Depending on the type and configuration of the device 1, the configuration module 4 can be assigned centrally to all the levels E1 to E2 and can be stored in one of the components K1 to K3, preferably in the central component K1. In addition to, or as an alternative, the configuration module 4 can be assigned to and stored in each component K1 to K3. The settings or the configuration criteria M1 to M3 of the different components K1 to K3 are managed by the configuration module 4 and taken into account and processed during the data exchange.

For example, all the data D of the project are stored on the component K1 that is configured as the central server. On this central component K1 of the level E1, the project-specific data D of the topographically lower components K2 to K3 of the level E2 are stored. For this purpose, the data D are transmitted via the communication network 2. Conversely, data D valid throughout the network can be transmitted from the topographically higher component K1 of the level E1 to the lower components K2 to K3 and can be stored there. With the configuration module 4, the data D are processed and stored using configuration criteria M1 to M3.

For this purpose, the configuration criteria M1 to M3 contained in the configuration module 4 are determined at the corresponding node elements 6 during the data exchange and are taken into account when the data D are processed and, in particular, when they are stored. For example, the central computer K1, the local computers K2, K3, or another project computer or terminal of the same level E1 to E2 are determined as the node element 6. Due to the configuration module 4 being associated with the individual components K1 to K3 and including the corresponding configuration criteria M1 to M3 in the form of text information or a database, the settings or configurations can be processed, modified and/or adapted independently of the components K1 to K3. For example, if a new component K4 corresponding to the component K3 is newly integrated in the communication network 2, the K3-specific settings are copied and automatically generated for the component K4 using the configuration module 4.

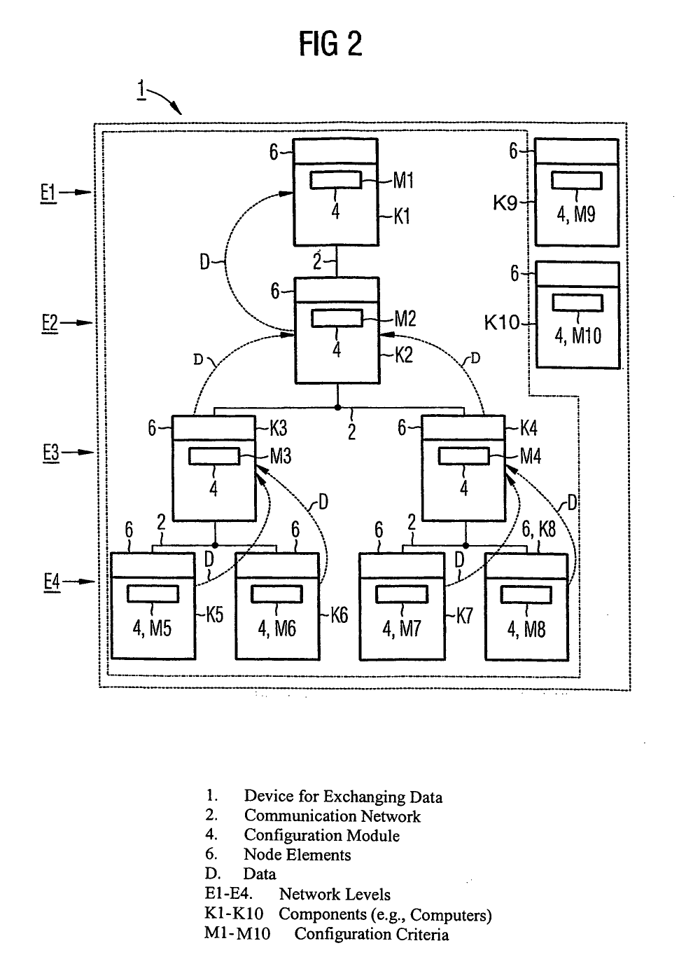

FIG. 2 shows a project-specific communication network 2. The components K1 to K8 are hierarchically arranged in multiple levels E1 to E4. As shown in FIG. 2, each component K1 to K8 can include an associated configuration module 4 in which both global, i.e., company-specific and/or project-specific configuration criteria M1 to M2 or network-specific configuration criteria M3 to M4, and local, i.e., computer-specific and/or user-specific configuration criteria M5 to M8, are stored. Furthermore, two central components K9 and K10 each have an associated configuration module 4. The respective configuration module 4 can contain, for example, default settings as central configuration criteria M9 and/or user settings that are valid for all components as central configuration criteria M10. The central or global components K9 and K10 are, for example, a central computer, particularly a monitoring or engineering computer or a server.

When data are exchanged, a directory of a file or a component K1 to K10, for example, is mapped from a source system, i.e., from a transmitting component K3, during the transmission by the configuration criteria M3 at the corresponding node element 6 to the directory of the file or the component K1 to K10 of a target system, i.e., a receiving or a newly generated component K4. Depending on type and configuration, both the reception-specific configuration criteria M4 and the transmission-specific configuration criteria M3 are taken into account in the data exchange. Data D can be exchanged within a single level E1, E2, E3 or E4 or several levels E1 to E4.

In addition to automatically taking into account the corresponding settings in an exchange of data D between the different components K1 to K10 by means of the configuration criteria M1 to M10, the configuration criteria can also be used to identify all the components K1 to 10 in the entire communication network 2 which have the same settings. In another analysis, all the configuration criteria K1 to K10 relating to a single component K1 to K10 can be determined. In both of these analyses, based on the node element 6, which is defined by one of the components K1 to K10, the configuration criteria M1 to M10 relating to these components K1 to K10 are determined by passing through the levels E1 to E4 in ascending sequence. In other words, the configuration criteria M1 to M10 of a topographically lower component K8 are identified through the configuration criteria M1 to M4 of topographically higher components K1 to K4.

For example, in the higher-level configuration module 6 of the component K2, a device editor is defined as a configuration criterion M2 for a project. All the subsequent components K3 to K8, terminals or CPUs in the levels E3 to E4 are likewise assigned this configuration criterion M2. The configuration criterion M2 associated with all the components K3 to K8 can be stored in the corresponding configuration module 4 in the central, and thus higher-level component K10 for user settings or locally in each component K3 to K8. In addition, the topographically lower components K3 to K8 can have their own user-specific configuration criteria M3 to M8, e.g., the factory setting “code-optimized” or “runtime-optimized,” which are stored centrally and/or locally as needed. Due to the identical structure of the configuration module 4 independent of the underlying heterogeneous components K1 to K10, the configuration criteria M1 to M10, which are configured as uniform or standardized settings, can be processed, e.g. modified generally, i.e., centrally, and/or locally. Central configuration criteria M1, M2, M9 to M10 can be processed and adapted locally and local configuration criteria M3 to M8 centrally, or vice versa.

Hence, regardless of the operating system or the program flow of the respective component K1 to K10, the configuration criteria M1 to M10 in a data exchange are processed by the configuration module 4 at the node elements 6 such that the transmitted data are transmitted, particularly stored, in a transmission-specific and/or reception-specific manner in accordance with the respectively valid configuration criterion M1 to M10. The settings of the components K1 to K10 to be linked, which relate to the data exchange, are determined at the respective node element 6 by the one or more configuration modules 4. For this purpose, the configuration criteria M1 to M10 relating to the data exchange are automatically determined by passing through the levels E1 to E4 in ascending or descending order, such that the configuration criteria M1 to M10 are predefined locally and/or centrally depending on where they are stored. When terminals or components K1 to K10 in a company are linked in a new project or in several projects, the configuration criteria M1 to M10 can be automatically centrally generated or modified. Depending on the type and structure of the communication network, e.g., a worldwide network of engineering terminals for processing a complex project, or a local, i.e. a national or company-specific network, the configuration criteria M1 to M10 include project-specific, country-specific, application-specific and/or hierarchy-specific settings.

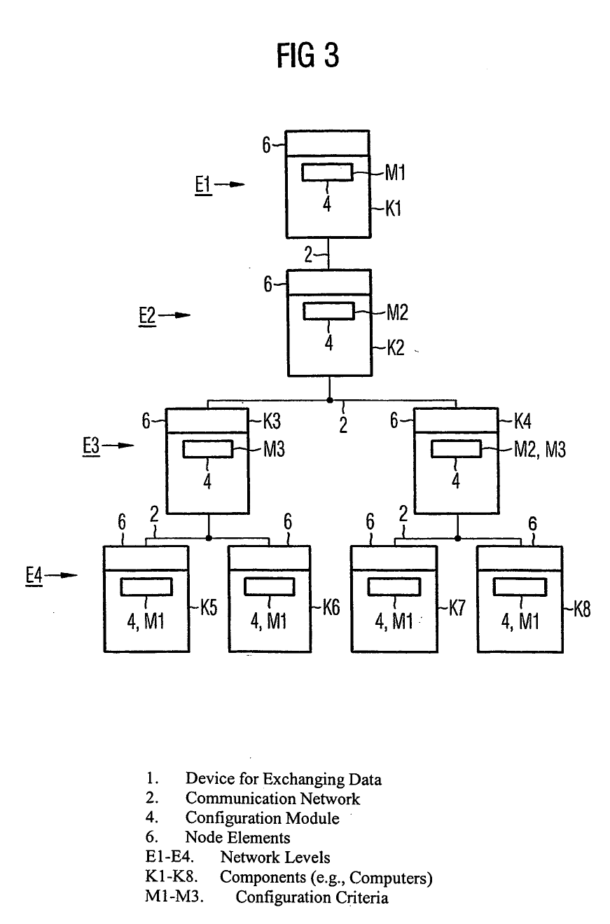

FIG. 3 shows an exemplary embodiment for constructing component-specific configuration modules 4 to store configuration criteria M1 to M3. All the configuration criteria M1 to M3 of an individual component K1 to K8 are combined in the respective configuration module 4 to form a group. For example, the central component K1 has a group “xxxx” with the settings “Group xxxx<NAME=“editor,” color=“red,” syntax=“IEC,” language=“German”>” as the configuration criteria M1. In the communication network 2 this group “xxxx” can be multiply defined as a central configuration criterion M1 and can be component-specifically and/or centrally stored. For example, the components K5 to K8 also have the configuration criterion M1 as a setting. This setting of the respective component K5 to K8 can thus be locally overwritten by the configuration criterion M1 of the topographically higher component K1.

For user-specific settings, the component K3, for example, has an associated configuration criterion M3. On the component K4, this configuration criterion M3 has been overwritten by the configuration criterion M2 of the topographically higher component K2. Thus, on the component K4, project-specific settings take precedence over user-specific settings. If necessary, each configuration module 4 can therefore include component-specific, group-specific, topographic and/or central configuration criteria M1 to M10.

The above description of the exemplary embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

1. A method for exchanging data between components of a communication network, which are arranged hierarchically in a plurality of levels, wherein a respective component is assigned at least one of application-specific and hierarchy-specific configuration criteria, which are processed by at least one configuration module associated with all the levels, such that, when the data are transmitted between components of one or more levels, the at least one of application-specific and hierarchy-specific configuration criteria stored in the at least one configuration module are at least one of transmission-specifically processed, reception-specifically processed and adapted at a node element associated with a respective level.

2. The method as claimed in claim 1, wherein the at least one configuration module is generated and stored at least one of component-specifically, group-specifically, topographically and centrally.

3. The method as claimed in claim 1, wherein the at least one configuration module is configured as a container.

4. The method as claimed in claim 1, wherein computer network-specific settings are predefined as the hierarchy-specific configuration criteria.

5. The method as claimed in claim 1, wherein computer-specific settings are predefined as the application-specific configuration criteria.

6. The method as claimed in claim 1, wherein a configuration criterion of a topographically lower component is determined by a configuration criterion of a topographically higher component.

7. The method as claimed in claim 1, wherein components with the same configuration criteria are combined into a group.

8. The method as claimed in claim 1, wherein, if one of the configuration criteria of one of the components is changed, corresponding configuration criteria in subsequent components of the hierarchy is adapted.

9. The method as claimed in claim 1, wherein the communication network is a computer network.

10. A method for configuring components of a communication network hierarchically arranged in a plurality of levels, wherein a respective component is assigned at least one of application-specific and hierarchy-specific configuration criteria, which are processed by at least one configuration module associated with all the levels, such that, when data are transmitted between components of one or more levels, the corresponding configuration criteria stored in the configuration module are adapted in at least one of a transmission-specific and reception-specific manner at a node element associated with a respective level.

11. A device for exchanging data between components of a communication network hierarchically arranged in a plurality of levels, wherein a respective component is assigned at least one of application-specific and hierarchy-specific configuration criteria, wherein at least one configuration module associated with all the levels and a node element associated with a respective level are provided for at least one of transmission-specific and reception-specific adaptation of the corresponding configuration criteria stored in the configuration module when data are transmitted between components of at least one of a single level and several levels.

12. The device as claimed in claim 11, wherein the configuration module is configured and stored at least one of component-specifically, group-specifically, topographically and centrally.

13. The device as claimed in claim 11, wherein the configuration module is configured as a container.

14. The device as claimed in claim 11, wherein the communication network is a computer network.

15. A computer readable medium including a program comprising instructions, which when executed, perform exchanging data between components of a communication network, which are arranged hierarchically in a plurality of levels, wherein a respective component is assigned at least one of application-specific and hierarchy-specific configuration criteria, which are processed by at least one configuration module associated with all the levels, such that, when the data are transmitted between components of one or more levels, the at least one of application-specific and hierarchy-specific configuration criteria stored in the configuration module are at least one of transmission-specifically processed, reception-specifically processed and adapted at a node element associated with a respective level.
